(19) United States
(12) Patent Application Publication
(10) Pub. No.: US 2025/0292158 A1
(43) Pub. Date: Sep. 18, 2025

(54) SYSTEM AND METHOD FOR REDUCTION AND INTERPRETABILITY OF A CONTINUOUS ACTION PROBABILITY TREE

(71) Applicant: GM Global Technology Operations LLC, Detroit, MI (US)

(72) Inventors: Ronit Bustin, Kfar Saba (IL); Claudia Goldman-Shenhar, Mevasseret Zion (IL)

(21) Appl. No.: 18/604,955

(22) Filed: Mar. 14, 2024

(51) Int. Cl. G06N 20/20; B60W 60/00; G06F 18/23

(52) U.S. Cl. CPC G06N 20/20; B60W 60/001; G06F 18/23

(57) ABSTRACT

A system performs a method for increasing an efficiency of operating a device. A processor obtains a first decision tree usable in operation of the device, the first decision tree having a first level of having a parent node and a second level having at least a first child node and a second child node, wherein the first child node and the second child node are accessible from the parent node of the first level. The processor selects the parent node, identifies and clusters a first child node and a second child node to form a second decision tree having a clustered child node based on at least one feature in common between the first child node and the second child node, and determines a semantic meaning for the clustered child node that is not present in either first child node or the second child node.

### INTRODUCTION

The subject disclosure relates to operation of an autonomous vehicle using a decision tree and, in particular, to a system and method for reduction and addition of partial semantic meaning of the decision tree prior to use at the autonomous vehicle.

An autonomous vehicle or semi-autonomous vehicle can perform and use a decision tree that provides a logical framework for choosing a next action to be performed by the vehicle. The decision tree relates the current state of the vehicle to a plurality of possible future states. An algorithm is used to traverse the decision tree. As the algorithm traverses the decision tree, the number of computations increases by the size of the decision tree. Thus, additional usages of the algorithm over a large decision tree are reduced in real-time scenarios. Moreover, an action can lack semantic meaning, thereby hindering the ability of the action selected by the algorithm to be understood. Accordingly, it is desirable to provide a method for reduction of the decision tree and addition of semantic meaning while retaining information to allow for more computationally cost-effective implementation at the vehicle.

### SUMMARY

In one exemplary embodiment, a method of increasing an efficiency of operating a device is disclosed. The method includes obtaining a first decision tree usable in operation of the device, the first decision tree having a first level of having a parent node and a second level having at least a first child node and a second child node, wherein the first child node and the second child node are accessible from the parent node of the first level, selecting the parent node and identifying at least the first child node and the second child node, clustering the first child node and the second child node to form a second decision tree having a clustered child node, the clustered child node based on at least one feature in common between the first child node and the second child node, and determining a semantic meaning for the clustered child node, wherein the semantic meaning for the clustered child node is not present in either the first child node or the second child node.

In addition to one or more of the features described herein, wherein determining the semantic meaning further includes ordering the at least one feature based an amount the at least one feature contributes to the clustering.

In addition to one or more of the features described herein, the method further includes selecting a distinguishing feature from the at least one feature that contributes most to the clustering and assigning the semantic meaning to the clustered child node based on the distinguishing feature.

In addition to one or more of the features described herein, wherein the first decision tree includes a third level having nodes, each node of the third level being accessible from a node of the second level, the method further includes assigning the clustered child node as a clustered parent node, identifying the nodes of the third level associated with the clustered parent node and clustering the identified nodes of the third level.

In addition to one or more of the features described herein, the method further includes operating the device using the first decision tree to take an action based on one of the first child node and the second child node and presenting a reason for the action based on the semantic meaning for the clustered child node from the second decision tree.

In addition to one or more of the features described herein, the at least one feature includes at least one of a state of the device, a value of the action, and a spatial parameter of the action.

In addition to one or more of the features described herein, the parent node is a top node of the first decision tree.

In another exemplary embodiment, a system for increasing an efficiency of operation of a device is disclosed. The system includes a processor. The processor is configured to obtain a first decision tree usable in operation of the device, the first decision tree having a first level of having a parent node and a second level having at least a first child node and a second child node, wherein the first child node and the second child node are accessible from the parent node of the first level, select the parent node and identify at least the first child node and the second child node, cluster the first child node and the second child node to form a second decision tree having a clustered child node, the clustered child node based on at least one feature in common between the first child node and the second child node, and determine a semantic meaning for the clustered child node, wherein the semantic meaning for the clustered child node is not present in either the first child node or the second child node.

In addition to one or more of the features described herein, the processor is further configured to determine the semantic meaning by ordering the at least one feature based an amount the at least one feature contributes to the clustering.

In addition to one or more of the features described herein, the processor is further configured to select a distinguishing feature from the at least one feature that contributes most to the clustering and assign the semantic meaning to the clustered child node based on the distinguishing feature.

In addition to one or more of the features described herein, wherein the first decision tree includes a third level having nodes, each node of the third level being accessible from a node of the second level, and wherein the processor is further configured to assign the clustered child node as a clustered parent node, identify the nodes of the third level associated with the clustered parent node and clustering the identified nodes of the third level.

In addition to one or more of the features described herein, the processor is further configured to operate the device using the first decision tree to take an action based on one of the first child node and the second child node and present a reason for the action based on the semantic meaning for the clustered child node from the second decision tree.

In addition to one or more of the features described herein, the at least one feature includes at least one of a state of the device, a value of the action, and a spatial parameter of the action.

In addition to one or more of the features described herein, the parent node is a top node of the first decision tree.

In another exemplary embodiment, a vehicle. The vehicle includes a processor. The processor is configured to obtain a first decision tree usable in operation of the vehicle, the first decision tree having a first level of having a parent node and a second level having at least a first child node and a second child node, wherein the first child node and the second child node are accessible from the parent node of the first level, select the parent node and identify at least the first child node and the second child node, cluster the first child node and the second child node to form a second decision tree having a clustered child node, the clustered child node based on at least one feature in common between the first child node and the second child node, and determine a semantic meaning for the clustered child node, wherein the semantic meaning for the clustered child node is not present in either the first child node or the second child node.

In addition to one or more of the features described herein, the processor is further configured to determine the semantic meaning by ordering the at least one feature based on an amount the at least one feature contributes to the clustering.

In addition to one or more of the features described herein, the processor is further configured to select a distinguishing feature from the at least one feature that contributes most to the clustering and assigning the semantic meaning to the clustered child node based on the distinguishing feature.

In addition to one or more of the features described herein, wherein the first decision tree includes a third level having nodes, each node of the third level being accessible from a node of the second level, the processor is further configured to assign the clustered child node as a clustered parent node, identify the nodes of the third level associated with the clustered parent node and clustering the identified nodes of the third level.

In addition to one or more of the features described herein, the processor is further configured to operate the vehicle using the first decision tree to take an action based on one of the first child node and the second child node and present a reason for the action based on the semantic meaning for the clustered child node from the second decision tree.

In addition to one or more of the features described herein, the at least one feature includes at least one of a state of the vehicle, a value of the action, and a spatial parameter of the action.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle that can be operated in an autonomous mode or automated mode, in accordance with an exemplary embodiment;

FIG. 2 shows a portion of a decision tree that can be used to operate a vehicle, in an illustrative embodiment;

FIG. 3 shows a flowchart of a method for operating the vehicle using the decision tree, in an illustrative embodiment;

FIG. 4 shows a dataset of an illustrative node of an original decision tree, in an illustrative embodiment;

FIG. 5 is a diagram showing the decision tree of FIG. 2 with marks illustrating a first iteration of a tree reduction process, in an illustrative embodiment;

FIG. 6 is a diagram showing a second iteration of the tree reduction process, in an illustrative embodiment;

FIG. 7 shows an intermediate decision tree formed from the tree reduction process illustrated in FIGS. 5 and 6;

FIG. 8 shows a flowchart of a tree compression method disclosed herein, in an illustrative embodiment;

FIG. 9 shows a dataset for a clustered node of a reduced decision tree, in an illustrative embodiment; and

FIG. 10 shows a view of a dashboard of the vehicle, in an illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

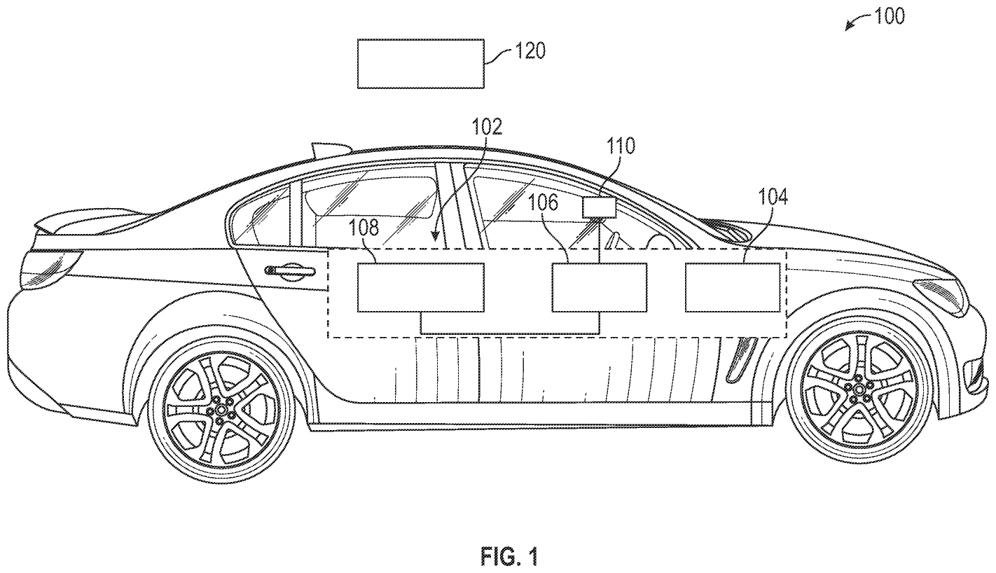

In accordance with an exemplary embodiment, FIG. 1 shows a vehicle 100 that can be operated in an autonomous mode or automated mode. The vehicle 100 can be a fully autonomous vehicle or a semi-autonomous vehicle. The vehicle 100 includes a driving system 102 that controls autonomous operation of the vehicle. The driving system 102 includes a sensor system 104 for obtaining information about the surrounding or environment of the vehicle 100, a controller 106 for computing possible actions for the autonomous vehicle based on the obtained information and for implementing one or more of the possible actions, and a human machine interface 108 for explaining the actions taken by the vehicle to an occupant of the vehicle, such as a driver or passenger. The human machine interface 108 need not be dedicated only to explaining actions and can be an interface that is used in the vehicle for purposes other than for explaining the actions. The sensor system 104 can include devices such as cameras, Lidar, radar, GPS, etc. The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of reducing a decision tree, adding a semantic meaning to the reduced decision tree and using the reduced decision tree at the vehicle 100 to provide a message explaining the action to an occupant of the vehicle based on the added semantic meaning, according to one or more embodiments detailed herein. The controller 106 can operate programs that perform artificial intelligence. The human machine interface 108 can include one or more interfaces, such as a speaker, a display, a haptic device, etc. Each interface is suitable for a given modality of a message. For example, the speaker can be employed to present an aural message. The display can be employed to present a written message or graph. The haptic device can be employed to present tactile message, such as a vibration, that is felt by the occupant. In another embodiment, the human machine interface 108 can be a mobile device that can be used by the occupant either while inside the vehicle or outside the vehicle.

The vehicle 100 also includes a communication unit 110 that can communicate with a remote processor 120. In various embodiments, the processor of the controller 106 and or the remote processor 120 can perform the methods disclosed herein for tree reduction and addition of semantic meaning to the decision tree, as disclosed herein.

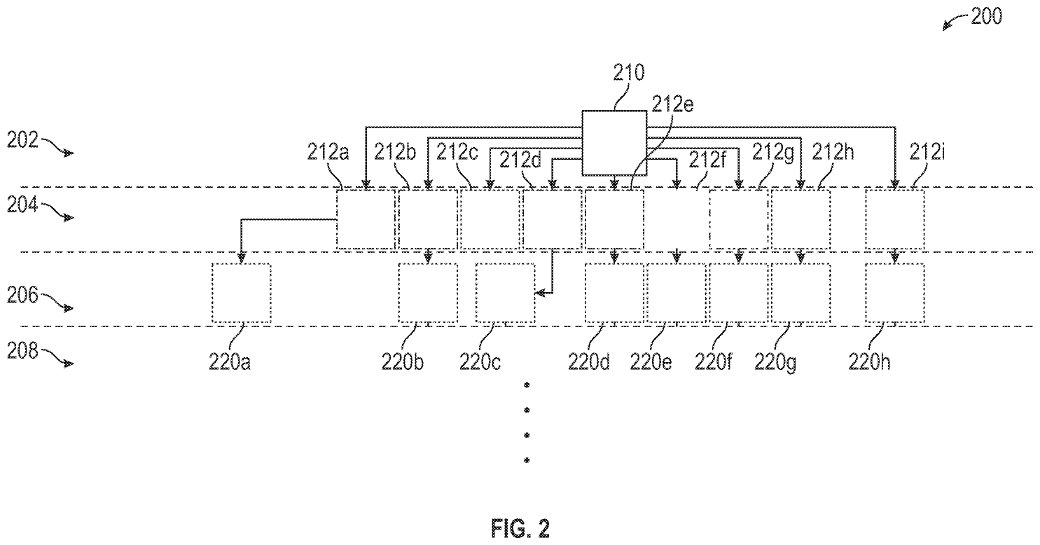

FIG. 2 shows a portion of a decision tree 200 that can be used by the controller 106 to operate a vehicle 100, in an illustrative embodiment. The decision tree 200 is a data structure that includes a plurality of nodes organized along branches. An edge connects any two nodes of the decision tree and can be parameterized by a probability for moving between one node to the connected node. Each node represents a state of the vehicle 100, and each edge represents an action that takes the vehicle from one state to another state (a subsequent state or future state). The decision tree 200 includes a plurality of levels. Each level includes one or more nodes of the decision tree 200. Although the decision tree 200 can have any number of levels, a first level 202, a second level 204, a third level 206, and a fourth level 208 are shown for illustrative purposes. The first level 202 includes a top node 210 representing the current state of the vehicle. The second level 204 includes nodes 212a-212i that can be accessed by the top node 210. The third level 206 includes nodes 220a-220h that can be accessed by nodes 212a-212i of the second level 204. This continues on through the remaining levels (not shown) of the decision tree. Nodes of consecutive levels can form a parent-child relation, with the node in the higher level (i.e., the level having the lower level number) being referred to as the parent and the node of the lower level (i.e., the level having the higher level number) being referred to as the child. Thus, for example, the top node 210 is a parent to nodes 210a-210i of the second level, which are children of the top node. Within the parent-child relation, a parent can have many children, but a child has only one parent.

The controller 106 selects the action to be performed as the best action from the root note of the tree (where “best” can be based on a number of visits or some other criterion). Once the action has been performed by the vehicle, a new tree can be constructed, based on the new current state of the vehicle. The construction of these trees can be implemented as in the Monte Carlo Tree Search algorithm.

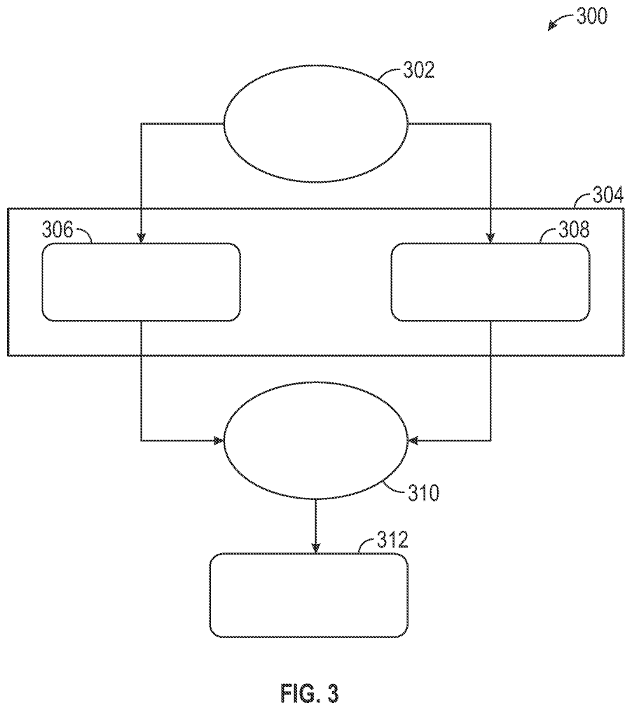

FIG. 3 shows a flowchart 300 of a method for operating a vehicle using an original decision tree or a first decision tree, in an illustrative embodiment. The method includes a reduction operation 304 that generates a reduced decision tree or second decision tree from the first decision tree. The second decision tree can be used to perform additional computations over the first decision tree, or for comparison between consecutive trees. Use of the second decision tree (instead of the first decision tree) reduces computation time and computation cost. The reduction operation 304 can be performed either offline or online. The reduction is performed after the first decision tree has been constructed. The first decision tree 302 (e.g., decision tree 200 of FIG. 2) is received. The first decision tree 302 is sent through the reduction operation 304, which includes two processes which are performed in parallel. The first process 306 is a clustering and unifying process and the second process 308 is an interpretability process. The clustering and unifying process reduces the first decision tree to a second (reduced decision tree) by forming clustered nodes within one or more levels of the tree. Nodes within a level are clustered and unified based on a commonality of a feature of the nodes to form a clustered node within the level. The children (in the subsequent layer) of the clustered node are then identified and clustering is performed among the children. The interpretability process determines a semantic meaning for a clustered node. The reduction operation 304 results in the second decision tree 310. When an action is taken that selects a clustered node of the second decision tree 310, the semantic meaning from the selected clustered node is displayed at the human machine interface 312.

In more detail, the tree reduction process receives a first decision tree. The first decision tree includes at least a first level having at least one parent node and a second level having at least a first child node and a second child node. The first child node and the second child node are accessible from the parent node of the first level by taking an action. A parent node is selected and the children (e.g., at least a first child node and a second child node) are identified. At least the first child node and the second child node are clustered together to form a clustered child node of a second decision tree, where the clustered child node is based on at least one feature in common between the first child node and the second child node, thereby producing a clustered child node that includes at least the first child node and the second child node. A semantic meaning is determined for the clustered child node and assigned to the child node. The semantic meaning for the clustered child node can be a meaning that is not present in any of the individual nodes that are clustered to make the clustered node. The result of these processes is a reduced decision tree. Additional computations can be performed on the reduced (second) decision tree, employing the clustered child node of the reduced decision tree. The vehicle is operated by implementing the first decision tree to select an action for the vehicle. The reason for the action is presented based on the corresponding clustered group in the second decision tree for more efficient computations and accessible semantic meaning.

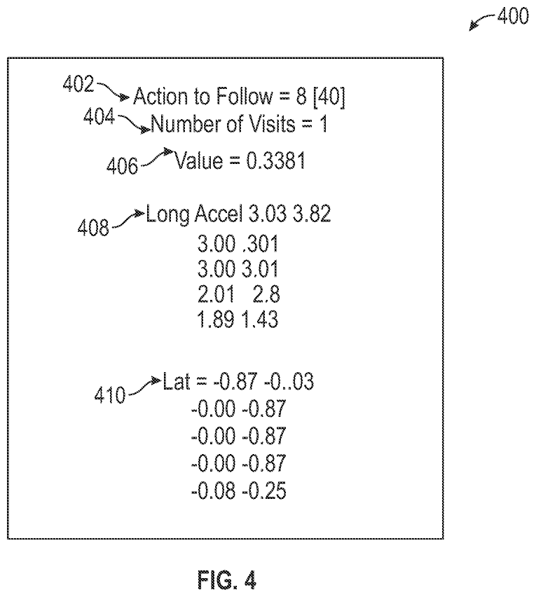

FIG. 4 shows a dataset 400 of an illustrative node of a first decision tree 302, in an illustrative embodiment. The dataset includes various features of the action, including the action 402 that is taken at the node and a number of visits 404. The features can be used during the clustering process. The features can also include state information, value components of the action, and spatial parameters of the action. State information includes information about the resulting state of the vehicle or other entities around the vehicle as a result of the action. The state information can include, but is not limited to, distance of other entities from the vehicle, their relative speed and position. Value components indicate a value of the action as it relates to the overall driving experience. Value components relate not only to the current action but also to possible future actions. Exemplary value components are indicated in FIG. 4 as value 406 and can include a headway (distance to next vehicle), a speed penalty relating to the curvature of the trajectory followed by the vehicle, a progress of the vehicle, a jerk experience at the vehicle, etc. An overall value of the action can be a weighted summation of the different components. Spatial parameters depict parameters of the action being taken at the node and can include features such as latitude 408 of the vehicle, longitude of the vehicle, acceleration 410 of the vehicle along the trajectory, etc.

The clustering of nodes is performed using the features found in the datasets of the nodes. For example, the clustering can be based on the velocity of the vehicle, the acceleration of the vehicle, the trajectory curvature, etc. The method of clustering the nodes includes applying a clustering algorithm to the node features. Exemplary clustering algorithms include, but are not limited to, k-means clustering, DBSCAN (Density-Based Spatial Clustering of Applications with Noise), HDBSCAN (Hierarchical Density-Based Spatial Clustering of Applications with Noise), etc.

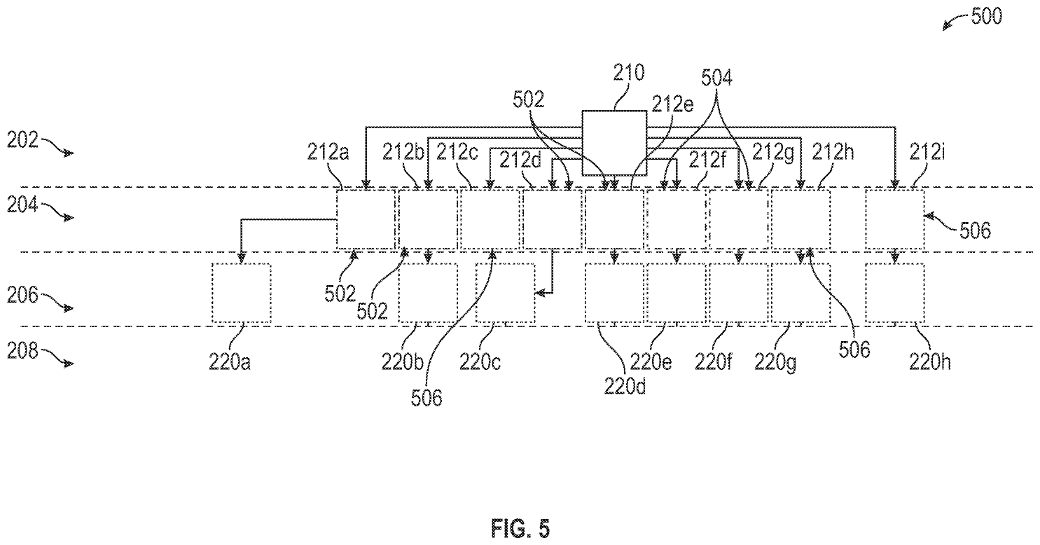

FIG. 5 is a diagram 500 showing the decision tree 200 of FIG. 2 with marks illustrating a first iteration of the tree reduction process, in an illustrative embodiment. A parent node is selected within the decision tree and children of the parent node are clustered according to their features. Although the node selected as a parent can be any node of the decision tree, the top node 210 is generally selected to start the reduction process. From the top node 210, the children are identified (i.e., the nodes 212a-212i) within the second level 204. The clustering process is performed on the children. (e.g., over nodes 212a-212i). As a result of the clustering, nodes 212a, 212b, 212d and 212e are grouped together based on values of their features to form a first clustered node 502. Also, nodes 212f and 212g are grouped together based on values of their features to form a second clustered node 504. Also, nodes 212c, 212h and 212i are grouped together based on values of their features to form a third clustered node 506.

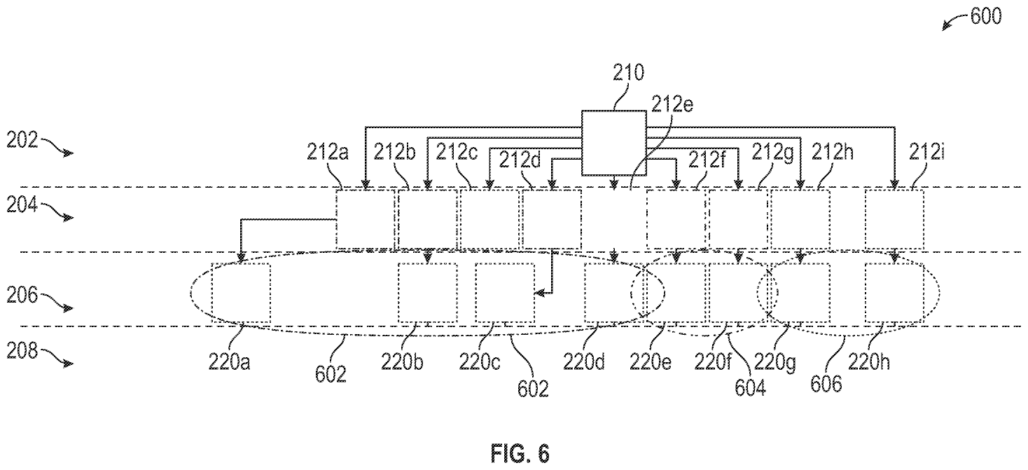

FIG. 6 is a diagram 600 showing a second iteration of the tree reduction process, in an illustrative embodiment. The second iteration includes performing the clustering process for the next level of the decision tree (e.g., at the third level 206). The clustered nodes of the second level 204 can now be labelled as clustered parent nodes. The children of each clustered node (e.g., the first clustered node 502, the second clustered node 504 and third clustered node 506) are identified. For the first clustered node 502, the children are identified as node 220a (child of node 212a), node 220b (child of node 212b), node 220c (child of node 212d) and node 220d (child of node 212e). These nodes are unified into a first sibling group 602. For the second clustered node 504, the children are identified as node 220e (child of node 212f) and node 220f (child of node 212g). These nodes are unified into a second sibling group 604. For the third clustered node 506, the children are identified as node 220g (child of node 212h) and node 220h (child of node 212i). These nodes are unified into a third sibling group 606. Clustering at this level is performed separately for each sibling group.

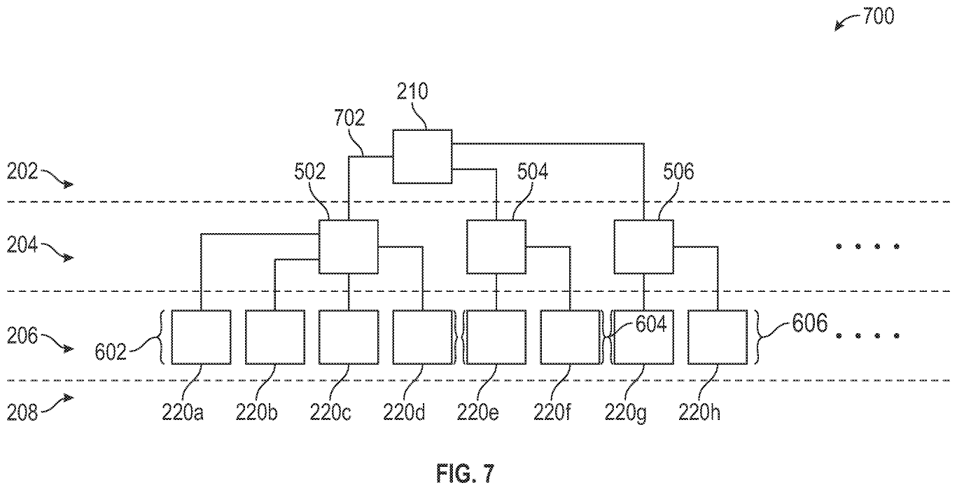

FIG. 7 shows an intermediate decision tree 700 formed from the tree reduction process illustrated in FIGS. 5 and 6. The intermediate decision tree includes the first clustered node 502, the second clustered node 504, the third clustered node 506, and any other clustered nodes of the second level 204. Edges from the decision tree 200 are replaced with appropriate reduced edges of the reduced decision tree. For example, the edges between the parent node 201 and nodes 212, 212b, 212d and 212e (FIG. 5) are replaced by a reduced edge 702. The nodes 220a, 220b, 220c and 220d, which are children, respectively, of nodes 212a, 212b, 212d and 212e, are now shown under the first clustered node 502 in the first sibling group 602. Nodes 220e and 220f, which are children, respectively of nodes 212f and 212g, are shown under the second clustered node 504 in the second sibling group 604. Nodes 220g and 220h, which are children, respectively of nodes 212h and 212i, are shown under the third clustered node 506 in the third sibling group 606.

With the intermediate decision tree 700, the nodes of the second level 204 that are within the same sibling group can be clustered using the clustering methods. For example, a first clustering is performed on the nodes of the first sibling group 602 (e.g., nodes 220a-220d), a second clustering is performed on the nodes of the second sibling group 604 (e.g., nodes 220e and 220f), a third clustering is performed on the nodes of the third sibling group 606 (e.g., nodes 220g and 220g), etc.

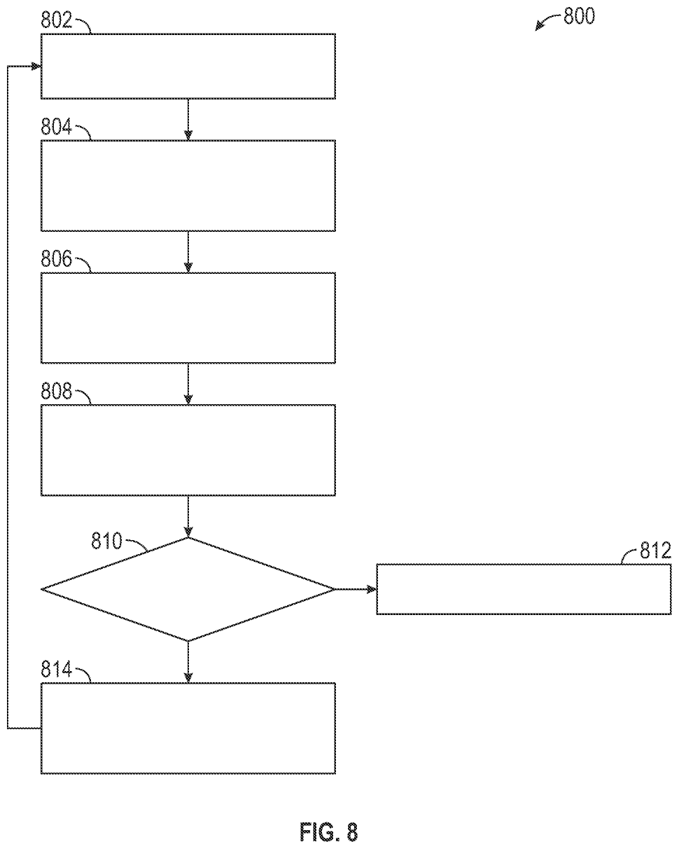

FIG. 8 shows a flowchart 800 of the tree reduction method disclosed herein, in an illustrative embodiment. In box 802, using the original decision tree, a parent cluster node is obtained and its children identified. For the first iteration, the parent cluster node is the top node 210 of the decision tree. In box 804, the children of the parent cluster node are clustered using a suitable clustering method. In box 806, an interpretability process is performed over the clustered children. In box 808, the children that are clustered into a group are unified into a clustered node. In box 810, a check is made as to whether the last level of the decision tree (or of a particular branch of the decision tree) has been reached. If the last level has been reached, the method proceeds to box 812 at which the method ends. At the end, the result is a reduced decision tree. Returning to box 810, if the last level has not been reached, the method proceeds to box 814. In box 814, a clustered child node is reassigned as a new parent cluster node. The children of the new parent cluster node are identified and gathered and the method returns to box 802.

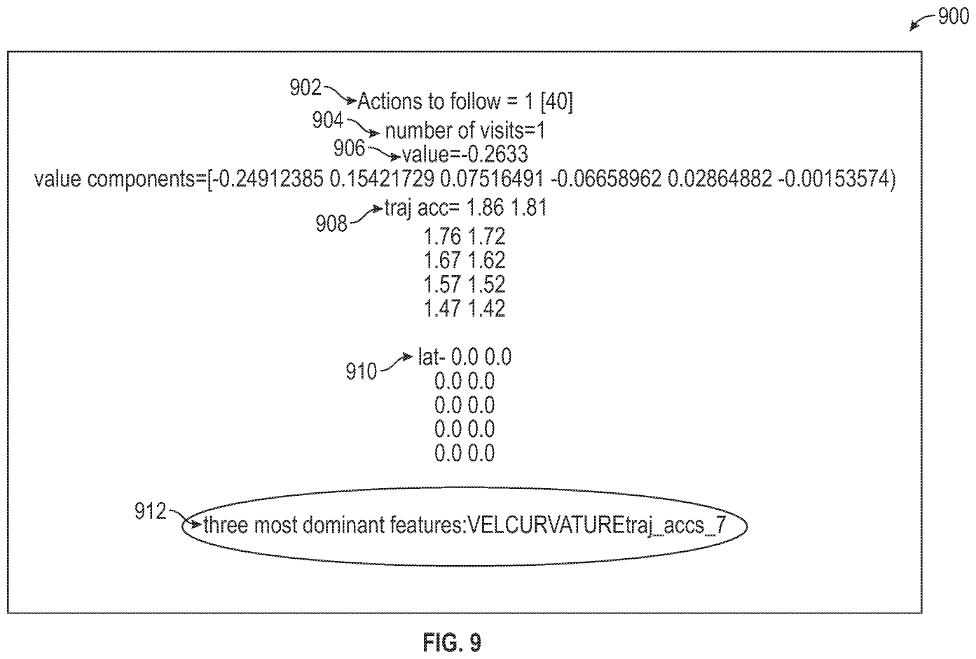

FIG. 9 shows a dataset 900 for a clustered node of the reduced decision tree in an illustrative embodiment. The dataset 900 includes the action 902 that is taken at the clustered node, a number of visits 904 and a value 906 of the action. The dataset 900 of the clustered node also shows various features of the action, such as the spatial parameters, value components and state information. For illustrative purposes, a trajectory acceleration 908, and a latitude 910 are shown. The dataset 900 also includes a record of the dominant features 912 used in the clustering process that created the clustered node. For illustrative purposes, the dominant features include the velocity (VEL), a curvature value of the trajectory (CURVATURE) and an acceleration (Traj_accel) at a selected point of the trajectory. Traj_accel refers to the acceleration at a 7^{th} point of the trajectory (out of 10 points defining the trajectory). The interpretability process organizes the features from most significant to least significant (with respect to the clustering process). A most significant feature can be considered a distinguishing feature of the clustered node.

Various methods for interpretability can be used. As an example, the interpretability problem can be transferred into a binary supervised clustering problem on which a Decision Tree (DT) or Random Forest (RF), which provide one or more prioritized distinguishing features.

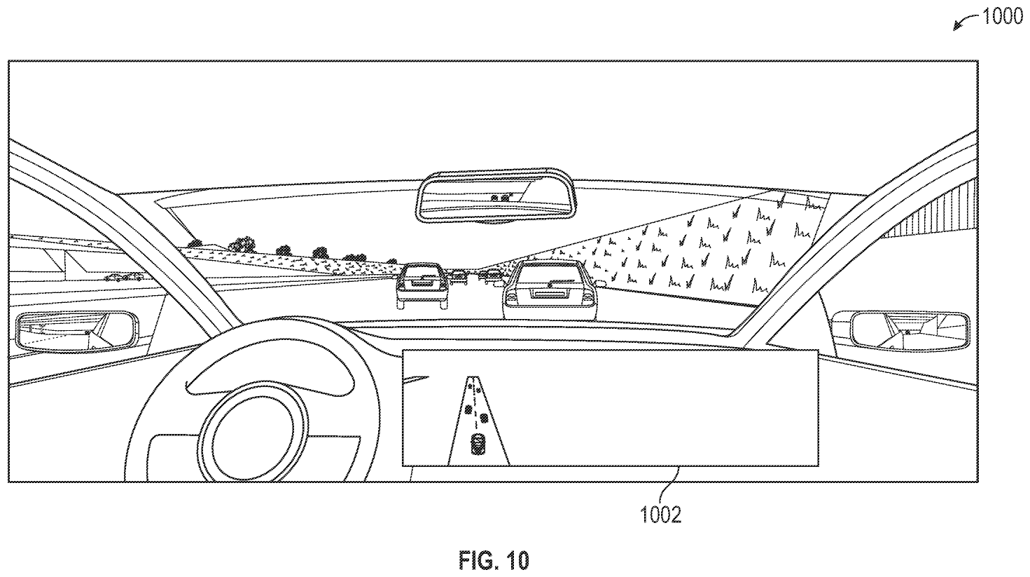

FIG. 10 shows a view 1000 of a dashboard of the vehicle 100, in an illustrative embodiment. When an action is taken at the vehicle 100, a message can be displayed at a display 1002 of the dashboard. The message explains a reason for taking the action to an occupant of the vehicle 100. The reason can be based on the action taken by the vehicle, a feature of the action taken by the vehicle, a value of the action taken by the vehicle, the state of the vehicle, or a combination thereof. Alternatively, the reason can be a contrastive explanation that explains why the action was taken in contrast, or as a benefit with respect to, a non-taken action. The reasons can be based on a distinguishing feature from the clustered node. For example, the message can state “We chose to perform this action since the velocity and longitudinal jerk of this action performs better than another action” or “We chose a stronger deceleration because we get a larger headway,” etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a level, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for increasing an efficiency of operating a device, comprising:
obtaining a first decision tree usable in operation of the device, the first decision tree having a first level of having a parent node and a second level having at least a first child node and a second child node, wherein the first child node and the second child node are accessible from the parent node of the first level;
selecting the parent node and identifying at least the first child node and the second child node;
clustering the first child node and the second child node to form a second decision tree having a clustered child node, the clustered child node based on at least one feature in common between the first child node and the second child node; and
determining a semantic meaning for the clustered child node, wherein the semantic meaning for the clustered child node is not present in either the first child node or the second child node.

2. The method of claim 1, further comprising wherein determining the semantic meaning further comprises ordering the at least one feature based an amount the at least one feature contributes to the clustering.

3. The method of claim 2, further comprising selecting a distinguishing feature from the at least one feature that contributes most to the clustering and assigning the semantic meaning to the clustered child node based on the distinguishing feature.

4. The method of claim 1, wherein the first decision tree includes a third level having nodes, each node of the third level being accessible from a node of the second level, the method further comprising assigning the clustered child node as a clustered parent node, identifying the nodes of the third level associated with the clustered parent node and clustering the identified nodes of the third level.

5. The method of claim 1, further comprising operating the device using the first decision tree to take an action based on one of the first child node and the second child node and presenting a reason for the action based on the semantic meaning for the clustered child node from the second decision tree.

6. The method of claim 5, wherein the at least one feature includes at least one of: (i) a state of the device; (ii) a value of the action; and (iii) a spatial parameter of the action.

7. The method of claim 1, wherein the parent node is a top node of the first decision tree.

8. A system for increasing an efficiency of operation of a device, comprising:
a processor configured to:
obtain a first decision tree usable in operation of the device, the first decision tree having a first level of having a parent node and a second level having at least a first child node and a second child node, wherein the first child node and the second child node are accessible from the parent node of the first level;
select the parent node and identify at least the first child node and the second child node;
cluster the first child node and the second child node to form a second decision tree having a clustered child node, the clustered child node based on at least one feature in common between the first child node and the second child node; and
determine a semantic meaning for the clustered child node, wherein the semantic meaning for the clustered child node is not present in either the first child node or the second child node.

9. The system of claim 8, wherein the processor is further configured to determine the semantic meaning by ordering the at least one feature based an amount the at least one feature contributes to the clustering.

10. The system of claim 9, wherein the processor is further configured to select a distinguishing feature from the at least one feature that contributes most to the clustering and assign the semantic meaning to the clustered child node based on the distinguishing feature.

11. The system of claim 8, wherein the first decision tree includes a third level having nodes, each node of the third level being accessible from a node of the second level, and wherein the processor is further configured to assign the clustered child node as a clustered parent node, identify the nodes of the third level associated with the clustered parent node and clustering the identified nodes of the third level.

12. The system of claim 8, wherein the processor is further configured to operate the device using the first decision tree to take an action based on one of the first child node and the second child node and present a reason for the action based on the semantic meaning for the clustered child node from the second decision tree.

13. The system of claim 12, wherein the at least one feature includes at least one of: (i) a state of the device; (ii) a value of the action; and (iii) a spatial parameter of the action.

14. The system of claim 8, wherein the parent node is a top node of the first decision tree.

15. A vehicle, comprising:
a processor configured to:
obtain a first decision tree usable in operation of the vehicle, the first decision tree having a first level of having a parent node and a second level having at least a first child node and a second child node, wherein the first child node and the second child node are accessible from the parent node of the first level;
select the parent node and identify at least the first child node and the second child node;
cluster the first child node and the second child node to form a second decision tree having a clustered child node, the clustered child node based on at least one feature in common between the first child node and the second child node; and
determine a semantic meaning for the clustered child node, wherein the semantic meaning for the clustered child node is not present in either the first child node or the second child node.

16. The vehicle of claim 15, wherein the processor is further configured to determine the semantic meaning by ordering the at least one feature based on an amount the at least one feature contributes to the clustering.

17. The vehicle of claim 16, wherein the processor is further configured to select a distinguishing feature from the at least one feature that contributes most to the clustering and assigning the semantic meaning to the clustered child node based on the distinguishing feature.

18. The vehicle of claim 15, wherein the first decision tree includes a third level having nodes, each node of the third level being accessible from a node of the second level, and wherein the processor is further configured to assign the clustered child node as a clustered parent node, identify the nodes of the third level associated with the clustered parent node and clustering the identified nodes of the third level.

19. The vehicle of claim 15, wherein the processor is further configured to operate the vehicle using the first decision tree to take an action based on one of the first child node and the second child node and present a reason for the action based on the semantic meaning for the clustered child node from the second decision tree.

20. The vehicle of claim 19, wherein the at least one feature includes at least one of: (i) a state of the vehicle; (ii) a value of the action; and (iii) a spatial parameter of the action.
